(19) United States
(12) Patent Application Publication
(10) Pub. No.: US 2023/0004166 A1
(43) Pub. Date: Jan. 5, 2023

(54) SYSTEMS AND METHODS FOR ROUTE SYNCHRONIZATION FOR ROBOTIC DEVICES

(71) Applicant: Brain Corporation, San Diego, CA (US)

(72) Inventors: Dan Sackinger, San Diego, CA (US); Jarad Cannon, San Diego, CA (US); Josh Klein, San Diego, CA (US); Daniel Woodlands, San Diego, CA (US)

(21) Appl. No.: 17/942,804

(22) Filed: Sep. 12, 2022

Related U.S. Application Data
(63) Continuation of application No. PCT/US21/22125, filed on Mar. 12, 2021.
(60) Provisional application No. 62/989,026, filed on Mar. 13, 2020.

(51) Int. Cl. G05D 1/02

(52) U.S. Cl. CPC G05D 1/0221; G05D 1/0274; G05D 1/0234; G05D 1/0287

(57) ABSTRACT

Systems and methods for route synchronization between two or more robots to allow for a single training run of a route to effectively train multiple robots to follow the route.

### PRIORITY

This application is a continuation of International Patent Application No. PCT/US21/22125 filed Mar. 12, 2021 and claims the benefit of U.S. Provisional Patent Application Ser. No. 62/989,026 filed on Mar. 13, 2020 under 35 U.S.C. § 119, the entire disclosure of each is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for route synchronization for robotic devices.

### SUMMARY

The foregoing needs are satisfied by the present disclosure, which provides for, inter alia, systems and methods for route synchronization for robotic devices. The systems and methods herein are directed towards a practical application of data collection, management, and robotic path navigation to drastically reduce time spent by human operators training multiple robots to follow multiple routes.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot may generally refer to an autonomous vehicle or object that travels a route, executes a task, or otherwise moves automatically upon executing or processing computer-readable instructions.

According to at least one non-limiting exemplary embodiment, a method, a non-transitory computer-readable medium or a system for causing a succeeding robot to navigate a route previously navigated by a preceding robot is disclosed. The method comprising the succeeding robot receiving a computer-readable map, the computer-readable map being produced based on data collected by at least one sensor of the preceding robot during navigation of the route by the preceding robot at a preceding instance in time; and navigating the route at a second instance in time by the succeeding robot based on the computer-readable map, the preceding instance in time being before the succeeding instance in time.

According to at least one non-limiting exemplary embodiment, the preceding robot, upon completing the route, communicates the computer-readable map to a server communicatively coupled to both the first robot and preceding robot.

According to at least one non-limiting exemplary embodiment, the preceding robot is navigating the route for an initial time in a training mode during the preceding instance in time, and the succeeding robot navigates the route for the succeeding time by recreating the route executed by the preceding robot during the preceding instance in time.

According to at least one non-limiting exemplary embodiment, the route begins and ends proximate to a landmark or feature recognizable by sensors of the succeeding and preceding robots.

According to at least one non-limiting exemplary embodiment, the computer-readable map comprises a pose graph indicative of positions of the robot during navigation of the route.

According to at least one non-limiting exemplary embodiment, the method may further comprise synchronizing data with a server upon initializing the succeeding robot from an idle or off state, the synchronized data comprising at least the computer-readable map of the route.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a,” “an,” and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 is a functional block diagram of a cloud server and communicatively coupled to devices thereto, in accordance with some embodiments of this disclosure.

FIG. 3 is a process flow diagram illustrating a method for a controller of a robot to initialize the robot to facilitate route synchronization, according to an exemplary embodiment.

FIG. 4 is a process flow diagram illustrating a method for a controller of a robot to navigate a route to facilitate route synchronization, according to an exemplary embodiment.

FIG. 5 is a process flow diagram illustrating a method for a controller of a robot to learn a new route and synchronize the new route with other robots within its environment, according to an exemplary embodiment.

FIGS. 6A-B is a top down view of two robots utilizing route synchronization to navigate a new route, according to an exemplary embodiment.

FIG. 7A is a top down or birds-eye view of a map comprising a route navigated by a preceding robot, according to an exemplary embodiment.

FIG. 7B is a top down view of a map comprising a succeeding, larger robot modifying a route received from a preceding small robot to enable the succeeding robot to follow the route of the preceding robot without collisions with objects, according to an exemplary embodiment.

FIG. 8 is a process flow diagram illustrating a method for a controller of a robot to determine if a route received from a different type or sized robot is navigable, according to an exemplary embodiment.

FIGS. 9A-B illustrate two robots synchronizing binary data from a server using metadata stored in ledgers, according to an exemplary embodiment.

FIG. 10 illustrates binding trees used to synchronize routes between two robots as illustrated in FIGS. 9A-B.

All Figures disclosed herein are © Copyright 2021 Brain Corporation. All rights reserved.

### DETAILED DESCRIPTION

Currently, many robots navigate along predetermined routes or paths, only deviating slightly from the routes to avoid obstacles. Many robots may operate within a single environment, such as a warehouse, department store, airport, and the like. Training multiple robots to follow multiple different routes can become very time consuming for operators of these robots. Training a robot typically comprises pushing, leading, or otherwise indicating a path for the robot to follow and requires human input. The time required to train multiple robots to follow multiple routes scales multiplicatively with the number of robots and number of routes, thereby causing human operators to spend a substantial amount of time training the robots for each route. Alternatively, separate robots may be designated separate routes, however this limits the utility of each individual robot to a select few routes. Accordingly, there is a need in the art for systems and methods for route synchronization between two or more robots to allow for a single training run of a route to effectively train multiple robots to follow the route.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for route synchronization for robotic devices. As used herein, a robot may include mechanical and/or virtual entities configurable to carry out a complex series of tasks or actions autonomously. In some exemplary embodiments, robots may be machines that are guided and/or instructed by computer programs and/or electronic circuitry. In some exemplary embodiments, robots may include electro-mechanical components that are configurable for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway, etc.), trailer movers, vehicles, and the like. Robots may also include any autonomous and/or semi-autonomous machine for transporting items, people, animals, cargo, freight, objects, luggage, and/or anything desirable from one location to another.

The present disclosure provides for systems and methods for route synchronization among a plurality of robotic devices in a shared environment. The plurality of robotic devices may travel through the shared environment using a plurality of routes. As used herein, the term “route” refers to a general path that a robot or plurality of robots may use to travel or navigate through the environment, such as from a starting point to an endpoint past one or more landmarks or objects in the environment. Without limitation, the starting point and the endpoint may be at the same location, providing a closed loop route. Alternatively, the starting point and the endpoint may be at different locations, providing an open-ended route. Further, a plurality of routes may be combined to provide a larger route. The term “run” is a single instance of a robot traveling along a route. The route does not necessarily comprise an identical track or path through the environment from run to run, but may be modified depending on factors such as a change of conditions encountered during a run by a robot, a different robot executing a run, etc. Each run may be timestamped to provide a listing of runs in chronological order. The term “route synchronization” refers to sharing information about a given route among the plurality of robots determined during a plurality of runs executed by the plurality of robots for the given route in the shared environment.

Because route synchronization involves sharing information among a plurality of robots gathered during a plurality of runs, the information is gathered at different time points. As used herein, the term “initial” refers to the chronologically earliest time or run that any robot of the plurality of robots travels a given route in the shared environment. The terms “preceding,” “precedes” and variations thereof refer to a chronological time earlier than other times or runs in which the plurality of robots operates in the shared environment. These terms also are used to describe a robot traveling a route (i.e. a run) earlier in time than the same or a different robot travels the route. As such, the initial time or initial run is chronologically earlier than all other times or runs. The terms “succeeding,” “succeeds” and variations thereof refer to a chronological time later than other times in which the plurality of robots operates in the shared environment, and also refer to robots executing runs later than other runs. By way of illustration but not limitation, a route through the shared environment may be traveled by the plurality of robots for a plurality of n runs, wherein n is a range of integers starting at 1, such as 1, 2, 3, up to n. An initial run is a run wherein n is 1, and the initial robot is the robot that executes the initial run. For a plurality of runs wherein n is greater than 1, the initial run (i.e. Run₁), is a preceding run to all other runs in the plurality of n runs, and all runs wherein n is greater than 1 are succeeding runs to the initial run. Further, Runₙ₋₁ is a preceding run to Runₙ, which is a succeeding run to Runₙ₋₁. An additional run (i.e. Run₊₁) is a succeeding run to Runₙ, which is a preceding run to Run₊ₙ. Similar nomenclature is used herein to refer to a robot executing a run in the plurality of runs. Notably, the robots executing the plurality of runs may be the same or different, in any combination or order.

As used herein, a feature may comprise one or more numeric values (e.g., floating point, decimal, a tensor of values, etc.) characterizing an input from a sensor unit 114 including, but not limited to, detection of an object, parameters of the object (e.g., size, shape color, orientation, edges, etc.), color values of pixels of an image, depth values of pixels of a depth image, brightness of an image, the image as a whole, changes of features over time (e.g., velocity, trajectory, etc. of an object), sounds, spectral energy of a spectrum bandwidth, motor feedback (i.e., encoder values), sensor values (e.g., gyroscope, accelerometer, GPS, magnetometer, etc. readings), a binary categorical variable, an enumerated type, a character/string, or any other characteristic of a sensory input.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, the term “processing device” refers to any processor, microprocessor, and/or digital processor and may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components. The term “processor” may be used herein as shorthand for any one or more processing devices described above.

As used herein, computer program and/or software may include any sequence or human- or machine-cognizable steps which perform a function. Such computer program and/or software may be rendered in any programming language or environment including, for example, C/C++, C#, Fortran, COBOL, MATLABTM, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVATM (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

As used herein, a computer-readable map may comprise any 2-dimensional or 3-dimensional structure representative of an environment in a computer-readable format or data structure, the map being generated at least in part by sensors on a robotic device during navigation along a route. Such formats may include 3-dimensional point cloud structures, birds-eye view maps, maps stitched together using a plurality of images, pixelated maps, and/or any other digital representation of an environment using data collected by at least one sensor in which a robot operates. Computer-readable maps may further comprise at least one route for a robot to follow superimposed thereon or associated with the maps. Some computer-readable maps may comprise additional data encoded therein in addition to two- or three-dimensional representations of objects; the additional encoded data may include color data, temperature data, Wi-Fi signal strength data, and so forth.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) drastically reduce time spent by humans training a plurality of robots to follow a plurality of routes, (ii) allow for rapid integration of new robots in environments comprising robots, and (iii) increase utility of existing robots by enabling existing robots to quickly exchange routes and tasks between each other. Other advantages are readily discernible by one having ordinary skill in the art given the contents of the present disclosure.

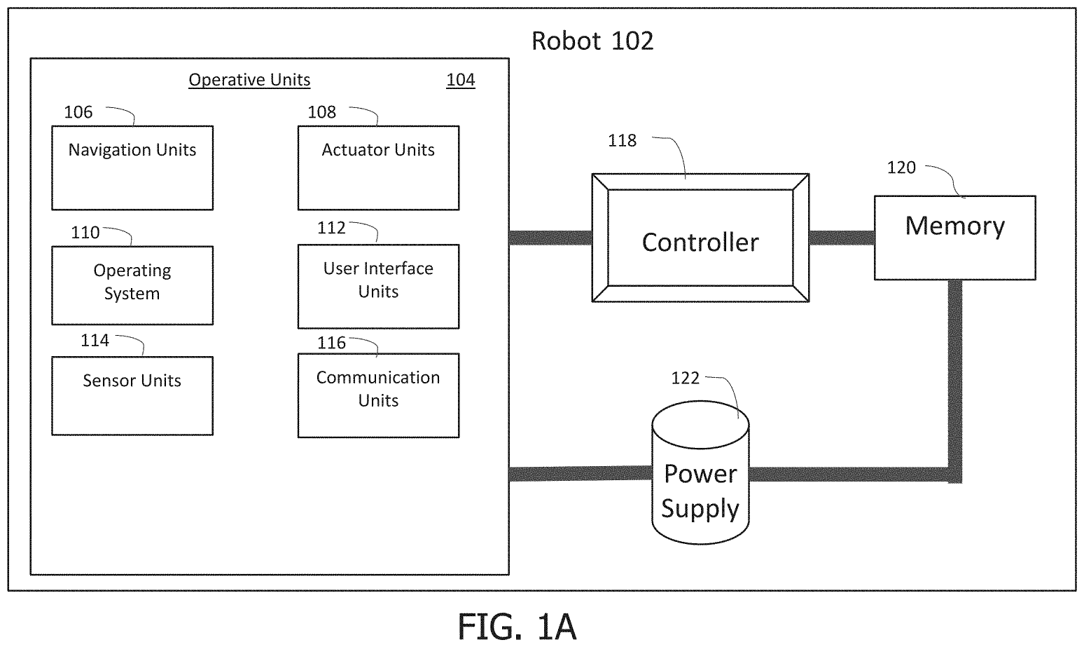

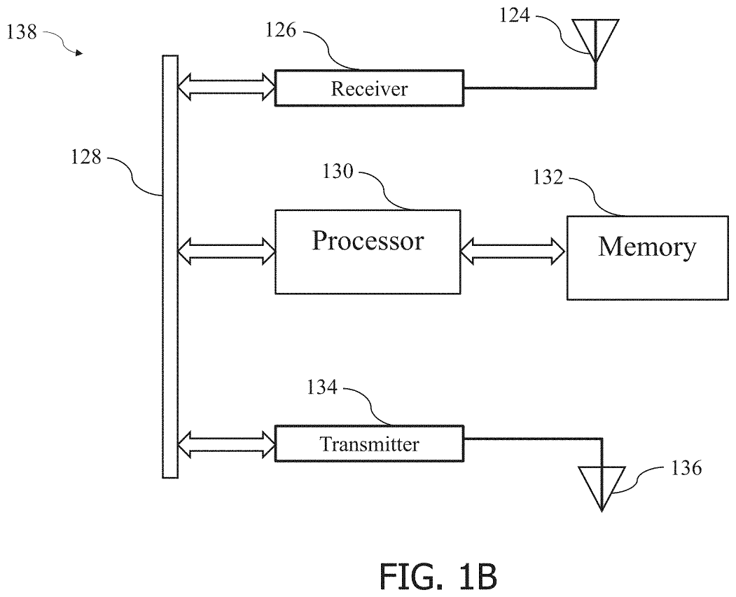

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), general-purpose (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Peripherals may include hardware accelerators configured to perform a specific function using hardware elements such as, without limitation, encryption/description hardware, algebraic processing devices (e.g., tensor processing units, quadradic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configurable to store digital data including, without limitation, read-only memory (“ROM”), random access memory (“RAM”), non-volatile random access memory (“NVRAM”), programmable read-only memory

(“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configurable to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configurable to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configurable to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units that provide the various functionality of robot 102. In exemplary embodiments, operative units 104 may be instantiated in software, hardware, or both software and hardware. For example, in some cases, units of operative units 104 may comprise computer-implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configurable to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configurable to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. According to exemplary embodiments, actuator unit 108 may include systems that allow movement of robot 102, such as motorized propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location. By way of illustration, such actuators may actuate the wheels for robot 102 to navigate a route, navigate around obstacles or move the robot as it conducts a task. Other actuators may rotate cameras and sensors. According to exemplary embodiments, actuator unit 108 may include systems that allow in part for task execution by the robot 102 such as, for example, actuating features of robot 102 (e.g., moving a robotic arm feature to manipulate objects within an environment).

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“TOF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configurable to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot 102's position (e.g., where position may include robot's location, displacement and/or orientation, and may sometimes be interchangeable with the term pose as used herein) relative to the initial location. Such data may be stored in data structures, such as matrices, arrays, queues, lists, stacks, bags, etc. According to exemplary embodiments, the data structure of the sensor data may be called an image.

According to exemplary embodiments, user interface units 112 may be configurable to enable a user to interact with robot 102. For example, user interface units 112 may include touch panels, buttons, keypads/keyboards, ports (e.g., universal serial bus (“USB”), digital visual interface (“DVI”), Display Port, E-Sata, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configurable to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configurable to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configurable to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configurable to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configurable to manage memory 120, controller 118, power supply 122, modules in operative units 104, and/or any software, hardware, and/or features of robot 102. For example, and without limitation, operating system 110 may include device drivers to manage hardware resources for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein below, a robot 102, a controller 118, or any other controller, processor, or robot performing a task illustrated in the figures below comprises a controller executing computer-readable instructions stored on a non-transitory computer-readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processing device 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer-readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

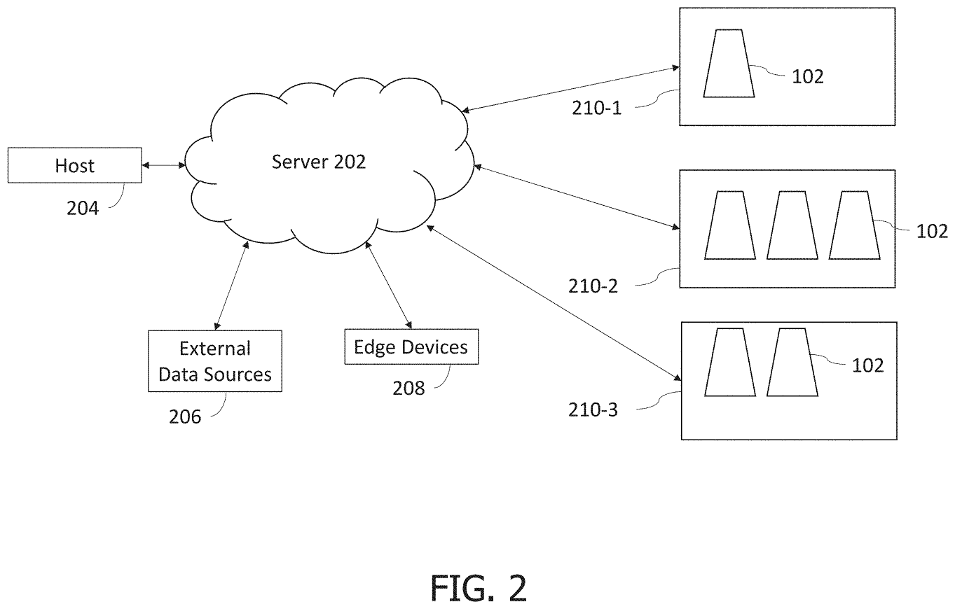

One of ordinary skill in the art would appreciate that the architecture illustrated in FIG. 1B may illustrate an external server architecture configurable to effectuate the control of a robotic apparatus from a remote location, such as server 202 illustrated next in FIG. 2. That is, the server may also include a data bus, a receiver, a transmitter, a processor, and a memory that stores specialized computer-readable instructions thereon.

One of ordinary skill in the art would appreciate that a controller 118 of a robot 102 may include one or more processing devices 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer-readable instructions to perform a function may include one or more processing devices 138 thereof executing computer-readable instructions and, in some instances, the use of any hardware peripherals known within the art. Controller 118 may be illustrative of various processing devices 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processing devices 138 for performing high-level tasks (e.g., planning a route to avoid obstacles) and processing devices 138 for performing low-level tasks (e.g., producing actuator signals in accordance with the route).

FIG. 2 illustrates a server 202 and communicatively coupled components thereof in accordance with some exemplary embodiments of this disclosure. The server 202 may comprise one or more processing devices depicted in FIG. 1B above, each processing device comprising at least one processor 130 and memory 132 therein in addition to, without limitation, any other components illustrated in FIG. 1B. The processing devices may be centralized at a location or distributed among a plurality of devices across many locations (e.g., a cloud server, distributed network, or dedicated server). Communication links between the server 202 and coupled devices may comprise wireless and/or wired communications, wherein the server 202 may further comprise one or more coupled antenna, relays, and/or routers to effectuate the wireless communication. The server 202 may be coupled to a host 204, wherein the host 204 may correspond to a high-level entity (e.g., an admin) of the server 202. The host 204 may include computerized and/or human entities. The host 204 may, for example, upload software and/or firmware updates for the server 202 and/or coupled devices 208 and 210 via a user interface or terminal. External data sources 206 may comprise any publicly available data sources (e.g., public databases such as weather data from the national oceanic and atmospheric administration (NOAA), satellite topology data, public records, etc.) and/or any other databases (e.g., private databases with paid or restricted access) of which the server 202 may access data therein. Edge devices 208 may comprise any device configurable to perform a task at an edge of the server 202. These devices may include, without limitation, internet of things (IoT) devices (e.g., stationary CCTV cameras, smart locks, smart thermostats, etc.), external processors (e.g., external CPUs or GPUs), and/or external memories configurable to receive and execute a sequence of computer-readable instructions, which may be provided at least in part by the server 202, and/or store large amounts of data.

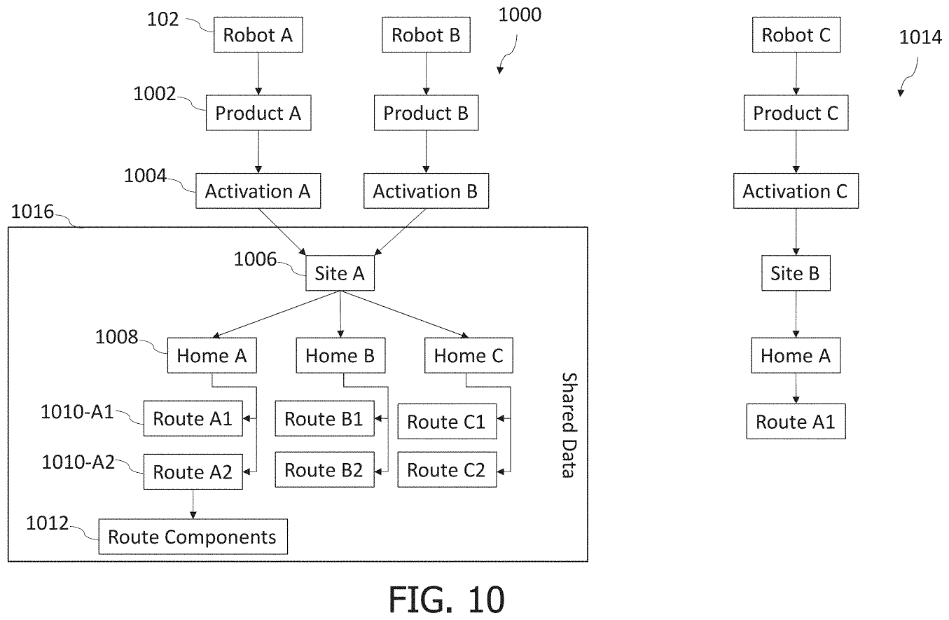

Lastly, the server 202 may be coupled to a plurality of robot networks 210, each robot network 210 comprising at least one robot 102. In some embodiments, each network 210 may comprise one or more robots 102 operating within separate environments from other robots 102 of other robot networks 210. An environment may comprise, for example, a section of a building (e.g., a floor or room), an entire building, a street block, or any enclosed and defined space in which the robots 102 operate. In some embodiments, each robot network 210 may comprise a different number of robots 102 and/or may comprise different types of robot 102. For example, network 210-1 may only comprise a robotic wheelchair, and network 210-1 may operate in a home of an owner of the robotic wheelchair or a hospital, whereas network 210-2 may comprise a scrubber robot 102, vacuum robot 102, and a gripper arm robot 102, wherein network 210-2 may operate within a retail store. Alternatively or additionally, in some embodiments, the robot networks 210 may be organized around a common function or type of robot 102. For example, a network 210-3 may comprise a plurality of security or surveillance robots that may or may not operate in a single environment, but are in communication with a central security network linked to server 202. Alternatively or additionally, in some embodiments, a single robot 102 may be a part of two or more networks 210. That is, robot networks 210 are illustrative of any grouping or categorization of a plurality of robots 102 coupled to the server. The relationships between individual robots 102, robot networks 210, and server 202 may be defined using binding trees or similar data structures, as discussed below in regards to FIG. 10.

Each robot network 210 may communicate data including, but not limited to, sensor data (e.g., RGB images captured, LiDAR scan points, network signal strength data from sensors 202, etc.), IMU data, navigation and route data (e.g., which routes were navigated), localization data of objects within each respective environment, and metadata associated with the sensor, IMU, navigation, and localization data. Each robot 102 within each network 210 may receive communication from the server 202 including, but not limited to, a command to navigate to a specified area, a command to perform a specified task, a request to collect a specified set of data, a sequence of computer-readable instructions to be executed on respective controllers 118 of the robots 102, software updates, and/or firmware updates. One skilled in the art may appreciate that a server 202 may be further coupled to additional relays and/or routers to effectuate communication between the host 204, external data sources 206, edge devices 208, and robot networks 210 which have been omitted for clarity. It is further appreciated that a server 202 may not exist as a single hardware entity, rather may be illustrative of a distributed network of non-transitory memories and processors. In some embodiments, a robot network 210, such as network 210-1, may communicate data, e.g. share route and map information, with other networks 210-2 and/or 210-3. In some embodiments, a robot 102 in one network may communicate sensor, route or map information with a robot in a different network. Communication among networks 210 and/or individual robots 102 may be facilitated via server 202, but direct device-to-device communication at any level may also be envisioned. For example, a device 208 may be directly coupled to a robot 102 to enable the device 208 to provide instructions for the robot 102 (e.g., command the robot 102 to navigate a route).

One skilled in the art may appreciate that any determination or calculation described herein may comprise one or more processors of the server 202, edge devices 208, and/or robots 102 of networks 210 performing the determination or calculation by executing computer-readable instructions. The instructions may be executed by a processor of the server 202 and/or may be communicated to robot networks 210 and/or edge devices 208 for execution on their respective controllers/processors in part or in entirety. Advantageously, use of a centralized server 202 may enhance a speed at which parameters may be measured, analyzed, and/or calculated by executing the calculations (i.e., computer-readable instructions) on a distributed network of processors on robots 102 and edge devices 208. Use of a distributed network of controllers 118 of robots 102 may further enhance functionality of the robots 102 as the robots 102 may execute instructions on their respective controllers 118 during times when the robots 102 are not in use by operators of the robots 102.

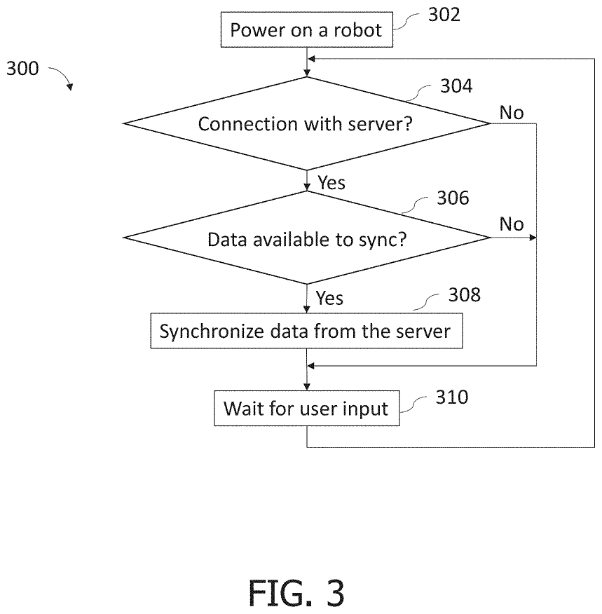

FIG. 3 is a process flow diagram illustrating a method 300 for powering on or initiating a robot 102 coupled to a server 202 for later use in route synchronization, according to an exemplary embodiment. Method 300 configures a controller 118 of a robot 102 to, upon being powered on or initiated, receive and store (in memory 120) up-to-the moment route and map data as well as software updates, firmware updates, and the like. Steps of method 300 may be effectuated by the controller 118 executing computer-readable instructions from a memory 120 as appreciated by one skilled in the art.

Block 302 comprises powering on of the robot 102. Powering on may comprise, for example, a human pressing an “ON” button of the robot 102 or a server 202 activating the robot 102 from an idle or off state. Powering on of the robot 102 may comprise, without limitation, activation of the robot 102 for a first (i.e., initial) time in a new environment or for a subsequent time within a familiar environment to the robot 102.

Block 304 comprises the controller 118 of the robot 102 checking for a connection to a server 202. Controller 118 may utilize communication units 116 to communicate via wired or wireless communication (e.g., using Wi-Fi or 4G, 5G, etc.) to the server 202. The server 202 may send and receive communications from the robot 102 and other robots 102 within the same or different locations. To verify the connection to the server 202, the controller 118 may, for example, send at least one transmission of data to the server 202 and await a response (i.e., a handshake verification).

Upon the controller 118 utilizing communications units 116 to successfully communicate with the server 202, the controller 118 moves to block 306.

Upon the controller 118 failing to communicate successfully with the server 202, the controller 118 moves to block 310.

According to at least one non-limiting exemplary embodiment, connection with the server 202 in block 304 may comprise connection to a local robot network 210, the local robot network 210 comprising at least one robot 102 within an environment. The local robot network 210 being a portion of the server 202 structure illustrated in FIG. 2 above local to the environment of the robot 102 (e.g., within the same building, using the same Wi-Fi, etc.). That is, connection to the server 202 is not limited to coupling of the robot 102 with all robots 102 of all robot networks 210, all data sources 206, the host 204, or edge devices 208.

Block 306 comprises the controller 118 checking if data is available to be synchronized (“syncing”) with the server 202. The server 202 may store computer-readable maps of an environment of the robot 102, for example, generated by the robot 102 in the past (e.g., during prior navigation of routes) or generated by at least one other robot 102 within the environment in one or more preceding runs of one or more routes. Data to be synchronized may comprise without limitation, software updates, firmware updates, updates to computer-readable maps, updates to routes (e.g., new routes from other robots 102, as discussed below), and/or any other data stored by the server 202 which may be of use for later navigation. Synchronizing of data may comprise the controller 118, via communications units 116, uploading and/or downloading data to/from the server 202. The controller 118 may communicate with the server 202 to determine if there is data to be synchronized with the server 202. Data may be pulled from the server 202 by the controller 118 or pushed from the server 202 to the controller 118, or any combination thereof.

For example, a preceding robot 102 may have a route stored within its memory 120, wherein the route was last completed by the preceding robot 102 at 5:00 AM, for instance, wherein the preceding robot 102 may synchronize data collected during navigation of the route with the server 202. At 6:00 AM the same day, for instance, a succeeding robot 102 (of the same make/model) may have navigated the same route and observed substantially the same objects with slight variations or, in some instances, substantial changes in the objects (e.g., changes in position, orientation, size, shape, presence, etc. of the objects). Accordingly, any time after 6:00 AM, both robots 102 may utilize data (e.g., sensor data and/or computer-readable maps) collected by the succeeding robot 102 as the data from the succeeding robot 102 is more up to date. The preceding robot 102, at any time after 6:00 AM, may synchronize with the server 202 to download the data from the succeeding robot 102.

Upon the controller 118 receiving communications from the server 202 indicative of data available to be synchronized, the controller 118 moves to block 308. Upon the controller 118 receiving communications from the server 202 indicative that all map and route data is up-to-the moment (i.e., no new data to be uploaded or downloaded), the controller 118 moves to block 310.

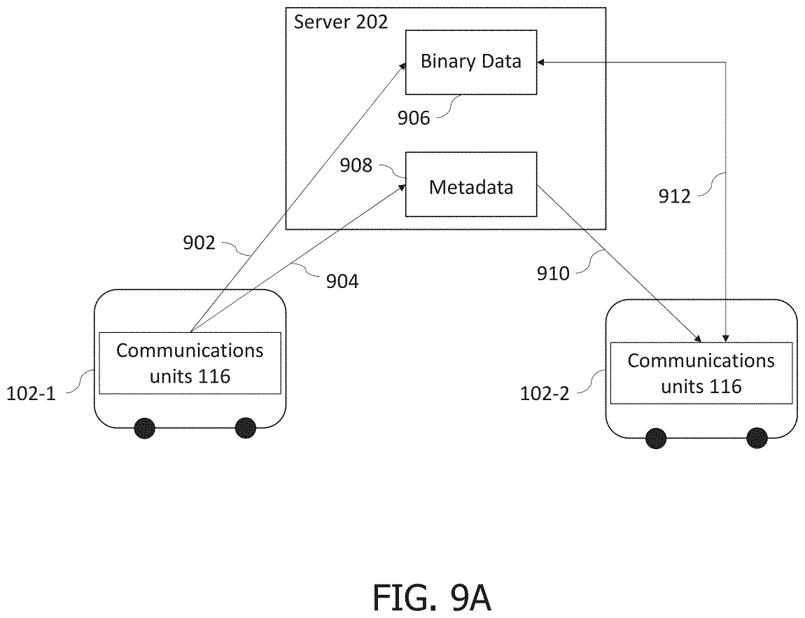

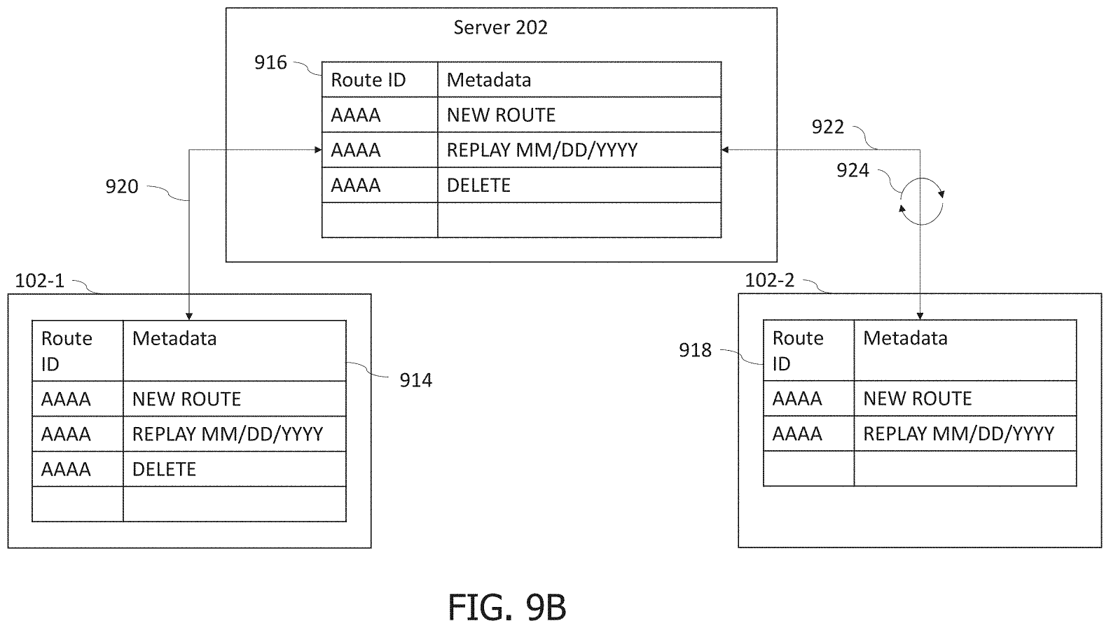

A more thorough discussion on how the controller 118 of the robot 102 and processors 130 of the server 202 know when data is available to be synchronized is shown and described in FIG. 9-10 below. In short, if a robot 102 detects any change to its routes (e.g., creation, edits, or deletions), the robot 102 may ping or transmit a signal to the server 202 communicating that there has been a change in its traveled route, which needs to be synchronized. Following this ping, the synchronization may occur as described next in block 308.

Block 308 comprises the controller 118 synchronizing data with the server 202. The data synchronized may comprise route data (e.g., pose graphs indicative of a path to be followed, a target location to navigate to and a shortest path thereto, etc.), map data (e.g., LiDAR scan maps, 3-dimensional points, 2-dimensional bird's eye view maps, etc.), software, and/or firmware updates. The route data may comprise updates to existing routes, for example, using data collected by other robots 102 within the same environment. The route data may include a pose graph, a cost map, a sequence of motion commands (e.g., motion primitives), pixels on a computer-readable map, filters (e.g., areas to avoid), and/or any other method of representing a route or path followed by a robot 102. The route data may further comprise new routes navigated by the other robots 102 within the same environment. The map data may comprise any computer-readable maps generated by one or more sensors from one or more robots 102 within the environment; the map data communicated may comprise the most up-to-the-moment map of the environment. In some embodiments, the map data may comprise a single large map or a plurality of smaller maps of the environment. In some embodiments, the map data may comprise the route data superimposed thereon. In some embodiments, the map data may include cost maps. In some embodiments, the map data may include multiple maps (i.e., representations of an environment) for a same route, for example, a point cloud map and a cost map.

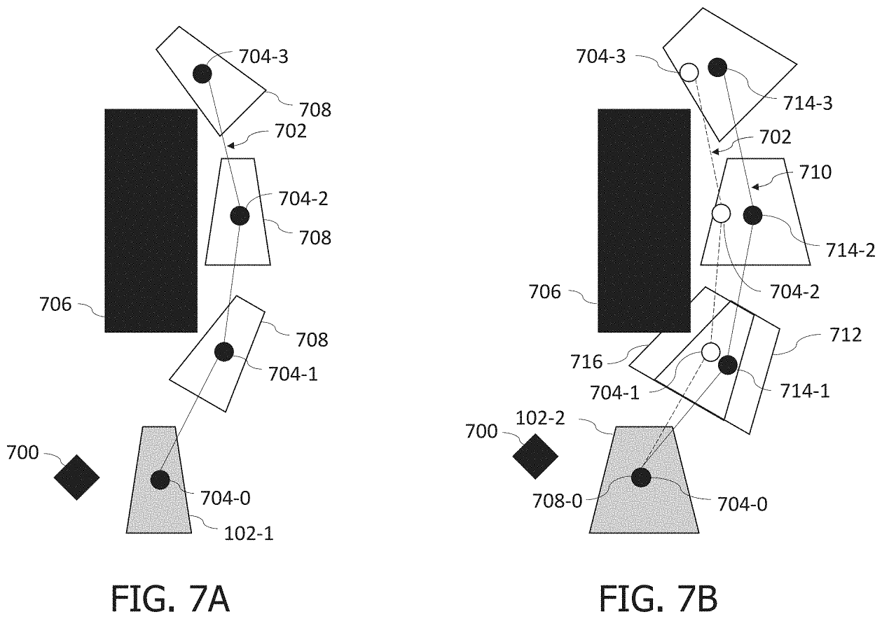

Route synchronization may be tailored to the robot receiving the information. As part of the connection with the server 202, characterization of the robot may be conducted. Characterization of the robot may include information related to, for example, its size, capability, executable tasks, and/or assigned functionality in the environments; its location (e.g., store number); and routes available to the robot 102, once synchronized. These characteristics may be defined using a binding tree or similar structure as shown and described in FIG. 10 below. In some embodiments, a robot 102 new to the environment may receive all route and map information related to the environment in 308. In other embodiments a robot 102 new to the environment may only receive route and map data in 308 relative to its function in the environment. For example, a floor-cleaning robot in a warehouse environment may receive map information related to cleaning floors but not receive information related to locations for stocking storage shelves. Following the same example, the floor-cleaning robot may receive route and map data from other floor-cleaning robots within the environment and not from shelf-stocking robots. In other embodiments, a robot may receive route information relevant to its size. See the discussion related to FIGS. 7A and 7B below for embodiments related to methods of modifying preceding route information to enable a robot to navigate a route based on its footprint.

Synchronizing of data between a robot 102 and a server 202 may comprise a delta update. A delta update, as used herein, occurs when a file, bundle, or component is updated by being provided with only new information. For example, a route file may be edited such that a segment of route is removed. To synchronize this update to the route from one robot 102 to another robot 102, only the update (i.e., removed segment) may be communicated rather than the entire map file. Advantageously, delta updates reduce communications bandwidth needed to update and synchronize files between robots 102 and server 202.

According to at least one non-limiting exemplary embodiment, the data available to be synced may include the deletion of a route. For example, a first robot 102 and a second robot 102 may operate in a single environment and/or be included in a robot network 210, both robots 102 having synchronized data with the server 202 such that both robots 102 comprise a set of routes stored in their respective memories 120. The first robot 102 may receive input from an operator, e.g., via user interface units 116, to delete a route from the set of routes stored in memory 120. Accordingly, the same route may be deleted from the memory 120 of the second robot 102 of the two robots 102 upon the second robot 102 being powered on (step 302) and synchronizing data with the server 202 following method 300.

According to at least one non-limiting exemplary embodiment, data synchronization may be specific to the environment of the robot 102. For example, a first robot network 210, comprising a plurality of robots 102, may operate within a first environment (e.g., a grocery store) and a second robot network 210, comprising a plurality of different robots 102, may operate within a different second environment (e.g., a warehouse). Upon a robot 102 of the first robot network 210 being initialized following method 300, the robot 102 may receive up-to-the-moment route and map data corresponding only to the first environment. In some instances, robots 102 of the first robot network 210 may be moved into the second environment of the second robot network 210. Accordingly, the robots 102 which have moved from the first environment to the second environment, and subsequently coupled to the second robot network 210, may receive data corresponding to the second environment upon reaching step 308, wherein data corresponding to the first environment may be deleted from their respective memories 120.

Block 310 comprises the controller 118 awaiting user input. The controller 118 may, for example, utilize user interface units 112 to display options to a human operator of the robot 102 such as “select a route to navigate,” “teach a route,” or other settings (e.g., delete a route, configuration settings, diagnostics, etc.). Methods 400, 500 below illustrate methods for the robot 102 and server 202 to maintain up-to-the-moment route and map data for later use in route synchronizing between two robots 102. Upon the controller 118 reaching step 310 following method 300, memory 120 of the robot 102 comprises some or all routes within the environment navigated by the robot 102 or navigated by other robots 102 in the past.

According to at least one non-limiting exemplary embodiment, while robot 102 is awaiting user input in block 310, controller 118 may communicate with the server 202 to determine (i) that connection to the server 202 still exists and, if so, (ii) if any new data is available to be synchronized. For example, upon following method 300 and awaiting a user input, the controller 118 may check if any new route or map data is available from the server 202 (e.g., from another robot 102 (i.e. a preceding robot 102) which had just completed its route while the succeeding robot 102 is being initialized) periodically, such as every 30 seconds, 1 minute, 5 minutes, etc. This may enable a robot 102 to receive up-to-the-moment route and map data from the server 202 even if after powering on the robot 102, the user becomes occupied and cannot provide the robot 102 with further instructions in block 310.

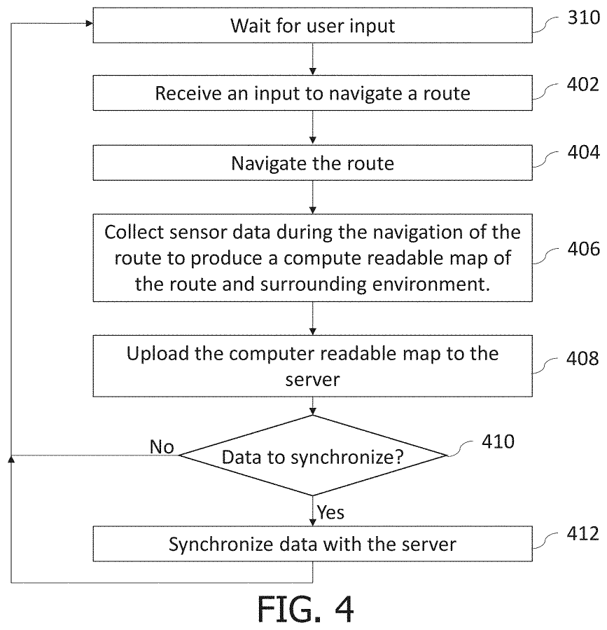

FIG. 4 is a process flow diagram illustrating a method 400 for a robot 102 to navigate a route and synchronize the route data with a server 202, according to an exemplary embodiment. Method 400 begins at block 310 (i.e., after initialization of the robot 102 using method 300) and proceeds to block 402 upon a server 202 or human operator indicating to the robot 102 (e.g., via user interface units 112) to navigate a route. Method 400 describes the process of synchronizing one component of a route, its map, wherein one skilled in the art may appreciate other components of a route, such as masks (e.g., no-go areas), tasks to complete at certain locations, pose graph information, etc., which may be synchronized in a substantially similar manner.

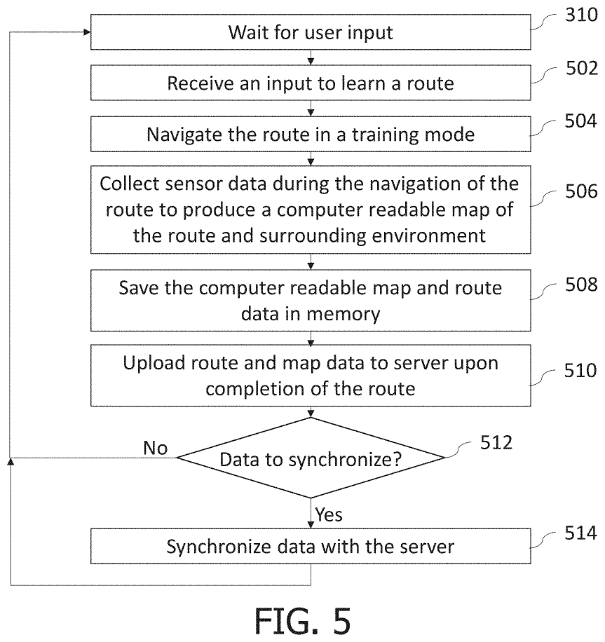

Block 402 comprises a controller 118 of the robot 102 receiving an input to navigate a route. The input may comprise a human operator selecting the route to navigate on a user interface unit 112 coupled to the robot 102. In some instances, the server 202 may configure the controller 118 to begin navigating the route in response to a human in a remote location indicating to the server 202 (e.g., via a device 208 or user interface) that the robot 102 is to navigate the route. In some instances, the server 202 may configure the controller 118 to navigate the route on a predetermined schedule or at specified time intervals. In some instances, the memory 120 of the robot 102 may include the predetermined schedule or time intervals for navigating the route, e.g., set by an operator of the robot 102. In some instances, the robot 102 may be trained to learn a route under user guided control (e.g., via an operator pushing, leading, pulling, driving, or moving the robot 102 along the route), as further discussed in FIG. 5 below.

Block 404 comprises the controller 118 navigating the route. The controller 118 may utilize any conventional method known in the art for navigating the route such as, for example, following a pose graph comprising positions for the robot 102 as a function of time or distance which, when executed properly, configure the robot 102 to follow the route. Navigation of the route may be effectuated by the controller 118 providing signals to one or more actuator units 108.

Block 406 comprises the controller 118 collecting data from at least one sensor unit 114 during navigation of the route to create a computer-readable map of the route and surrounding environment. The computer-readable map may comprise a plurality of LiDAR scans or points joined or merged to create a point cloud representative of objects within an environment of the robot 102 during navigation of the route. In some embodiments of a computer-readable map, the computer-readable map may comprise a plurality of greyscale or colorized images merged to produce the map. In at least one non-limiting embodiment of robot 102, sensor units 114 may further comprise gyroscopes, accelerometers and other odometry units configurable to enable the robot 102 to localize itself with respect to a fixed starting location and thereby accurately map its path during execution of the route. A plurality of methods for mapping a route navigated by the robot 102 may be utilized to produce the computer-readable map, wherein the method used in block 406 may depend on the types of sensors of sensor units 114, resolution of the sensor units 114, and/or computing capabilities of controller 118 as should be readily apparent to one skilled in the art.

According to at least one non-limiting exemplary embodiment, the computer-readable map of the environment may comprise a starting location, an ending location, landmark(s) and object(s) therebetween detected by sensor units 114 of the robot 102 or different robot 102 during prior navigation along or nearby the objects.

Block 408 comprises the controller 118, upon completion of the route, uploading the computer-readable map generated in block 408 to the server 202 via communications units 116. The computer-readable map uploaded to the server 202 may comprise route data (e.g., pose graphs, gyro meter data, accelerometer data, a path superimposed on the computer-readable map, etc.) and/or localization data of objects detected by sensor units 114 during navigation of the route.

According to at least one non-limiting exemplary embodiment, block 408 may comprise the controller 118 uploading summary information corresponding to the navigated route. The summary information may include data such as the runtime of the route, number of obstacles encountered, deviation from the route to avoid objects, a number of requests for human assistance issued during the navigation, timestamps, and/or performance metrics (e.g., square footage of cleaned floor if robot 102 is a floor-cleaning robot). That is, uploading of the computer-readable map is not intended to be limiting as computer-readable maps produced in large environments may comprise a substantial amount of data (e.g., 100kB to GB) as compared to metadata associated with navigation of the route. For example, robots 102 may be coupled to the server 202 using a cellular connection (e.g., 4G, 5G, or other LTE networks), wherein reduction in communications bandwidth may be desirable to reduce costs in operating the robots 102. The binary data of the computer-readable map may be kept locally on memory 120 on the robot 102 until the server 202 determines that another robot 102 may utilize the same map, wherein the binary data is uploaded to the server 202 such that the server 202 may provide the route and map data to the other robot 102.

According to at least one non-limiting exemplary embodiment, the controller 118 may upload metadata associated with the run of the route. The metadata may include, for example, a site identifier (e.g., an identifier which denotes the environment and/or network 210 of the robot 102), a timestamp, a route identifier (e.g., an identifier which denotes a specific route within the environment), and/or other metadata associated with the run of the route. The utility of metadata for determining if there is data available to be synchronized for the next step 410 is further illustrated in FIG. 9A-B below.

Block 410 comprises the controller 118 communicating with the server 202 to determine if there is data to be synchronized, similar to block 306 discussed in FIG. 3 above. The synchronization upon completion of the route enables the robot 102 to receive updated route data collected by another robot 102-A. For example, a first robot 102 may follow method 400 up to block 410 to navigate a first route while another, second robot 102 navigates and completes another route following method 400 and accordingly uploads a computer-readable map and route data to the server 202. The second robot 102 completes its respective route while the first robot 102 is still navigating its respective route, wherein the first robot 102 is pre-occupied with its task and cannot synchronize. Upon the second robot 102 completing its route, new route data may be synchronized between the second robot 102 and the server 202. Server 202, upon detecting a change to route data (e.g., creation, deletion, or edits to route data) from the second robot 102 may ping the first robot 102 indicating that new data is available to be synchronized. The receipt of this ping may indicate to the controller 118 of the first robot 102 that data is available to be synchronized. In other embodiments, the controller 118 may issue a ping to the server 202, wherein the server 202 may reply indicating that data is or is not available to be synchronized.

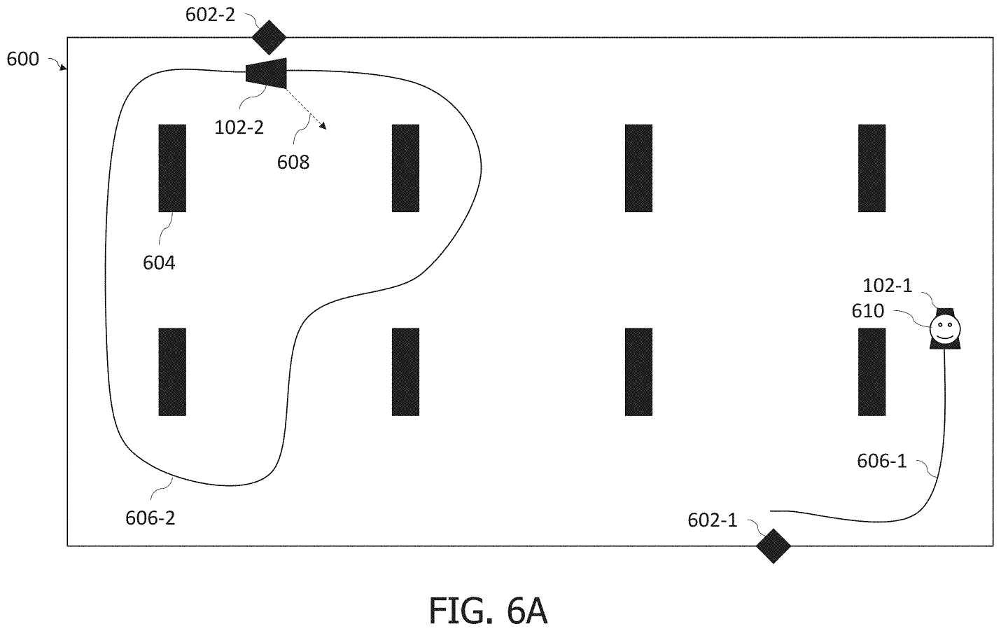

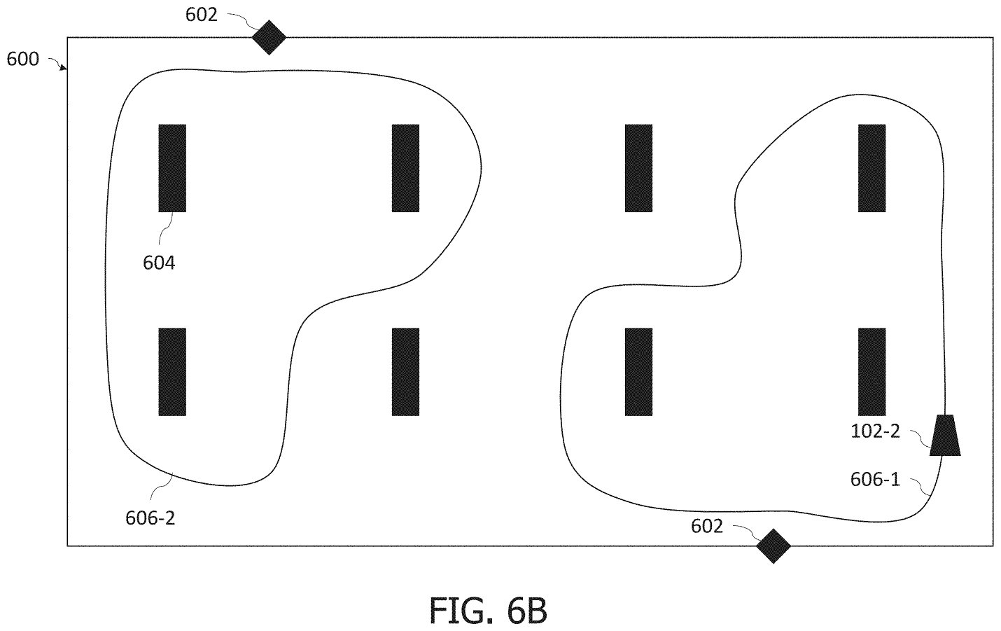

Upon the one robot 102 reaching block 410, the server 202 may have received the computer-readable map from the other preceding robot 102-A of the other route and may provide the computer-readable map to the one robot 102, thereby ensuring the computer-readable map of the other route stored in memory 120 of the one robot 102 is up-to-the-moment based on data collected by the other, preceding robot 102-A. A similar example is further illustrated below in FIG. 6A-B.

Upon the controller 118 receiving communication from the server 202 indicating there is no data to be synchronized with the server 202, the controller 118 returns to block 310 and awaits a user input.

Upon the controller 118 receiving communication from the server 202 indicating there is data to be synchronized, the controller 118 moves to block 412.

Block 412 comprises the controller 118 synchronizing data with the server 202. As mentioned previously, synchronizing data with the server 202 may comprise the robot 102 receiving software updates, firmware updates, updated computer-readable maps, updated or new routes (e.g., collected by other robots 102), and/or other data useful for navigation within its environment.

In some embodiments, the robot new to an environment may be the initial robot in the environment and no route and/or map information is available to be synchronized. In other embodiments, the robot may not be new to an environment but needs to learn a new route. Accordingly, the robot is the initial robot for the route and no route and/or map information for that route is available to be synchronized. In such embodiments, the robot is configurable to learn one or more routes taught by a user to the robot in a training mode as described in more detail below in relation to FIG. 5. The robot may also gather map and route data in an exploration mode also as described in more detail below.

New route or map data may comprise an entirely new route through the environment, or it may comprise an existing route modified to address one or more new conditions, such as a task being added or deleted, landmark(s) being added, deleted or moved, object(s) being added and/or different environmental conditions requiring which may necessitate the entirely new route. One of skill in the art can appreciate that the amount of human user input needed would be less for modifying an existing route than for teaching an entirely new route.

For illustration, a preceding route may include locations A, B, D and E, tasks a, b and d at locations A, B and D, and object C at location C1. A new route may comprise one in which locations A, B and E are unchanged, task b is deleted, location D and task d are deleted, object C is moved to new location C2 and location F and associated taskfare added. As a consequence the existing preceding route may be modified to define a new succeeding route to skip locations B and D, navigate around object C at new position C2, navigate to new location F and perform new task f at location F. In some embodiments, these changes to a preceding route may be effectuated by a human operator providing input to user interface units 116 or may require the human operator to navigate the robot 102 through the modified route.

In some embodiments, the entire new route can be taught to a robot in learning mode directed by a human user in an initial run. In other embodiments, a new succeeding route may be learned by a robot in training and/or exploration mode by navigating a preceding route with changes inputted by a human user as it navigates the preceding route. In still other embodiments, a new succeeding route can be configured into a robot 102 by modifying an existing preceding route by a processing device at the level of the controller 118, the network level 210 or the server level 202 by a combination of user inputs designating desired changes to the route and sensor data gathered during exploration mode of the robot.

FIG. 5 is a process flow diagram illustrating a method 500 for a robot 102 to learn a route and upload the learned route to a server 202, according to an exemplary embodiment. Method 500 begins at block 310 (i.e., after initialization of the robot 102 using method 300 and/or after execution of method 400) and proceeds to block 502 upon a human operator indicating to the robot 102 (e.g., via user interface units 112) to navigate a route.

Block 502 comprises the controller 118 receiving an input which configures the robot 102 to learn a route. The input may be received from a human operator via user interface units 112 coupled to the robot 102.

Block 504 comprises the controller 118 navigating the route in a training mode. The training mode may configure the controller 118 to learn the route as a human operator moves the robot 102 through the route. The robot 102 may be pushed, driven, directed, steered, remotely controlled, or led through the route by the operator. As the human operator moves the robot 102 through the route, the controller 118 may store position data (e.g., measured by sensor units 114) of the robot 102 over time to, for example, generate a pose graph of the robot 102 indicative of the route.

According to at least one non-limiting exemplary embodiment, learning of a route may comprise the robot 102 operating in an exploration mode to (i) detect and localize objects within its environment, and (ii) find a shortest and safest (i.e., collision free) path to its destination. The exploration mode may be executed using, for example, an area fill algorithm which configures the robot 102 to explore its entire area and subsequently calculate a shortest path. Exploration mode for use in learning or discovering an optimal route from a first location to another may be advantageous if ample time is provided, human assistance is undesired, and the environment comprises few dynamic or changing objects (e.g., warehouses, stores after they have closed to the public, etc.).

Block 506 comprises the controller 118 collecting data from sensor units 114 during navigation of the route to produce a computer-readable map of the route and surrounding environment. For example, the human operator may drive the robot 102 along the route, such as by remote control via user interface units 112 and communication units 116. As the robot 102 is being driven through the route, controller 118 may collect and store data from sensor units 114. The data collected may comprise any data useful for producing the computer-readable map and for later navigation of the route such as, without limitation, position data over time of the robot 102, LiDAR scans or point clouds of nearby objects, colorized or greyscale images, and/or depth images from depth cameras.

Block 508 comprises the controller 118 saving the computer-readable map and route data collected during navigation of the training route in blocks 504-506 in memory 120.

Block 510 comprises the controller 118, upon completing the route, uploading the route data and computer-readable map to the server 202. The route data and computer-readable map may be communicated to the server 202 via communications units 116 of the robot 102. According to at least one non-limiting exemplary embodiment, the computer-readable map and route data may be communicated via communications units 116 to a robot network 210 and thereafter relayed to the server 202.

Block 512 comprises the controller 118 communicating with the server 202 to determine if there is any data to be synchronized. Data to be synchronized may comprise computer-readable maps produced by other robots 102 during navigation of the training route, other routes, software updates, and/or firmware updates.

Upon the controller 118 receiving communication from the server 202 indicating there is no data to be synchronized with the server 202, the controller 118 returns to block 310 and awaits a user input.

Upon the controller 118 receiving communication from the server 202 indicating there is data to be synchronized, the controller 118 moves to block 514.

Block 514 comprises the controller 118 synchronizing with the server 202. Synchronizing with the server 202 may comprise the server 202 communicating any new route data, computer-readable maps (e.g., produced by other robots 102 in the same environment), software updates, and/or firmware updates. The steps illustrated in blocks 512-514 ensure all routes and computer-readable maps stored in memory 120 of the robot 102 are up-to-the-moment based on data received by other robots 102, external data sources 206, and/or edge devices 208.

Although uploading route and map data is described in blocks 408 and 512 as being after completion of a route, alternatively or additionally in some embodiments, such data may be uploaded continuously, periodically (such as every 30 seconds, 1 minute, 5 minutes, etc.), or occasionally (such as after encountering an object or landmark along the route) as the robot 102 travels along a route. This may enable synchronizing data among a plurality of robots 102 traveling through a shared environment. This may be advantageous if the uploaded data may be used to inform other (succeeding) robots of new conditions discovered by a (preceding) robot that might influence the ability of the other robots to travel along the routes they are navigating. This embodiment may be most advantageous for robots 102 with ample communications bandwidth. Such data synchronization in (near-)real time may be particularly useful in environments where a plurality of robots is operating contemporaneously.

An occasion wherein a robot 102 may upload route and map data prior to completion of a route may be when the robot 102 encounters a condition that prevents it or another robot 102 from completing a route. For illustration, a shelf-stocking robot navigating a route may encounter a spill. The shelf-stocking robot can upload data regarding the type and location of the spill to its network 210 and/or server 202 (e.g., a location of the spill on a computer-readable map). Based on that data, a determination can be made to activate a cleaning robot (see FIG. 3, block 302) and download data (block 308) to the spill location into the cleaning robot. In some embodiments, data about the condition, such as a spill, may also be the basis for a determination that a notification, sensor data etc. are to be sent to a higher-level controller, such as a server 202 or human user. After uploading data regarding the spill, the shelf-stocking robot may, for example, resume navigation of its route if possible (FIG. 4, block 404) or may revert to block 310 and wait for user input. After receiving data about the spill at block 308, the cleaning robot may wait for user input (block 310) or navigate to the spill location (block 404). Once the cleaning robot reaches the spill location, it may communicate with the server to upload and synchronize data (blocks 408, 410 and 412). The cleaning robot, depending on its instructions, may then wait for user input (block 310) or autonomously clean up the spill. Accordingly, both the shelf-stocking robot and cleaning robot may no longer localize the spill on their respective computer-readable maps upon the cleaning robot synchronizing data with the server 202 subsequent to cleaning of the spill.

FIG. 6A-B illustrate the methods 300, 400, and 500 for synchronizing routes between two robots 102-1 and 102-2, according to an exemplary embodiment. First, in FIG. 6A, one robot 102-1 is being taught a new route 606-1 by a human operator 610. Concurrently, a different robot 102-2 is navigating a route 606-2 which has been stored in the memory 120 of the robot 102-2 and synchronized with a server 202. Both routes 606-1, 606-2 may begin at their respective starting points 602-1, 602-2. The starting points 602-1, 602-2 may comprise a landmark (e.g., an image or feature) or any predetermined point within environment 600 such as, for example, a barcode or quick response (“QR”) code. Each landmark 602 may correspond to one or more routes 606 beginning and ending at the respective landmarks 602. In some embodiments, routes 606 may start and end at different landmarks 602. While the robot 102-1 is being taught the route 606-1 (e.g., by the operator 610 driving, pushing, leading, pulling, or otherwise demonstrating the route 606-1), the other robot 102-2 may have completed the route 606-2. Following method 400, the other robot 102-2 communicates with the server 202 a computer-readable map produced by data from sensor units 114 during navigation of the route 606-2, as illustrated by dashed arrow 608. The server 202 may utilize the computer-readable map to determine updates to the route 606-2 such as, for example, updating a position of one or more of objects 604, which may change over time.

Next, in FIG. 6B, robot 102-1 has completed its training of route 606-1 and, following method 500 above, uploads a computer-readable map generated by sensor data collected during navigation of route 606-1 to the server 202. This data will be synchronized with route and map data of the other robot 102-2 to provide the other robot 102-2 with the new route and corresponding computer-readable map produced by the robot 102-1 during training. At a later time, the operator 610 may configure the other robot 102-2 to navigate the route 606-1. Advantageously, due to the synchronization illustrated in methods 300, 400, 500 above, the other robot 102-2 may now comprise a computer-readable map and data for route 606-1 stored within its memory 120, the map for route 606-1 having been generated by robot 102-1. Similarly, robot 102-1 may also receive a map of route 606-2 after synchronizing with the server 202 following method 500. Accordingly, the robot 102-2 may begin navigating the second route 606-1 without a need for the operator 610 to teach it the new route 602-1. The robot 102-1 may, for example, navigate the route 606-2 or be powered off for later use. In the scenario depicted in FIGS. 6A and 6B, robot 102-1 is the preceding robot for route 606-1 and the succeeding robot for route 606-2. Likewise, robot 102-2 is the preceding robot for route 606-2 and the succeeding robot for route 606-1. Both robots 102 are able to navigate both routes 606-1 and 606-2 despite each robot 102-1 and 102-2 having only navigated different ones of the two routes 606-1, 606-2.

FIGS. 7A-B illustrate a method for synchronizing a route between two robots 102-1 and 102-2 of different types or comprising different footprints, according to an exemplary embodiment. The methods 300, 400, 500 above are applicable, however additional optimizations to a synchronized route may be required if the two robots 102-1, 102-2 between which the route is being synchronized comprise different sizes, tracks (e.g., differential drives, tricycle, four wheels), makes/models, etc. Further, one skilled in the art may appreciate that not all routes are capable of being navigated by all types of robots 102 and in some instances, route synchronization may not be possible.

FIG. 7A illustrates a robot 102-1 navigating a first route 702 beginning at a starting location 704-0, the first route 702 comprising a path around an object 706, the first route 702 comprising a pose graph, according to an exemplary embodiment. The starting location 704-0 being proximate to a landmark 700, the landmark 700 comprising a feature which denotes the start of route 702 (e.g., a QR code, an infrared beacon, audio beacon, light, and/or any other feature of an environment). The pose graph may comprise any of (x, y, z, yaw, pitch, roll) coordinates which denote a position of the robot 102 at each point 704, each point 704 being a predetermined distance or time along the route 702 (e.g., every 5 seconds robot 102-1 moves from (x₁, y₁, yawi) to (x₂, y₂, yawn)). Each point 704 may be illustrative of a pose of the pose graph. Illustrated for clarity is the footprint 708 (i.e., area occupied) of the robot 102-1 at each respective point 704 illustrated on a two-dimensional birds-eye view computer-readable map. Upon completion of the first route 702, the robot 102-1 may upload the resulting pose graph formed by points 704 as well as any additional localization data of the nearby object 706 to the server 202, following methods 400 or 500. Alternatively, the pose graph may be uploaded after each point 704 is reached by the robot 102.

Next, in FIG. 7B, a larger robot 102-2 may begin at the starting location 704-0 proximate to the same landmark 700 used to start the route 702 by the smaller robot 102 illustrated in FIG. 7A, according to an exemplary embodiment. Following methods 300, 400, or 500 above, large robot 102-2 may receive data for the route 702 including the pose graph executed by robot 102-1 and a computer-readable map which, in part, localizes object 706. The large robot 102-2 may perform a test to determine if the pose graph of route 702 is navigable by the large robot 102-2 without colliding with the object 706. The test comprises, for each point 704 (open circles) of the pose graph of route 702 (dashed line) controller 118 superimposing a simulated footprint 712 of the large robot 102-2 and determining if the footprint 712 intersects with object 706. If a potential collision (i.e., overlap between a simulated footprint 712 and object 710 on the map as shown by footprint 716 corresponding to the position of the large robot 102-2 at point 704-1) is detected, controller 118 may calculate changes to the route 702, such as moving the robot 102-2 farther from object 706, until no overlap between object 706 and footprints 712 occur to provide a new route 710. The calculated changes are represented by route 710 (solid line) comprising a pose graph containing poses 714 (closed circles) which causes the robot 102-2 to navigate farther from the object 706 than the robot 102-1. The initial pose 708-0 being the same as the initial pose 704-0 of the route 702. In this manner the controller 118 of the robot 102-2, or a processor on server 202 may project a footprint 712 at each point 704 of the pose graph of route 706 on the computer-readable map to determine if the route is navigable without collisions and if collisions occur determine any changes to the route to avoid collisions, such as prior to beginning the route.

In some embodiments, a controller 118 of the robot 102-2, or a processor on server 202, may modify and update all routes stored for robot 102-2 received from other robots (e.g., 102-1) to navigate through the environment and avoid collisions. In other embodiments, modification of routes for robot 102-2 may be made only as needed for each specific route.

One skilled in the art may appreciate that not all routes are navigable by all types of robots 102. For example, a small differential drive robot may navigate almost all routes navigable by a large tricycle robot; however, the large tricycle robot may not navigate all routes the smaller differential drive robot is able to navigate. Similarly, large robot 102-2 may find route 706 to be unnavigable without collisions, despite changes thereto, using footprints 712. For example, a path between two objects 706 (not shown) may be impassable using a large robot having a footprint 712.

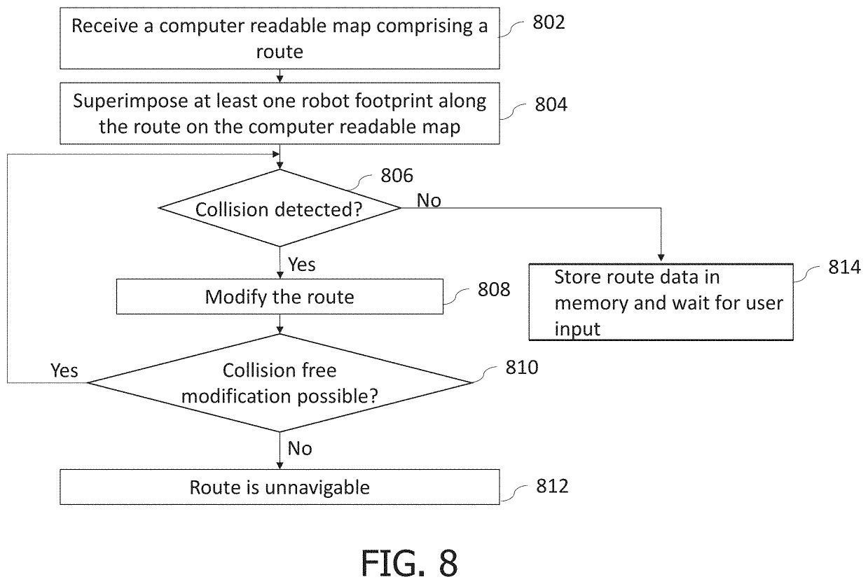

FIG. 8 is a process flow diagram illustrating a method 800 for a robot 102 to synchronize a route received from another robot 102 of a different type and/or size and determine if the route is navigable, according to an exemplary embodiment.

Block 802 comprises a controller 118 of a robot 102 receiving a computer-readable map comprising a route. The computer-readable map is received from a server 202 and produced by a different robot 102 of a different type, size, and/or shape.

Block 804 comprises the controller 118 superimposing at least one simulated robot footprint 712 along the received route. The robot footprint 712 comprises a projection (e.g., 2-dimensional top view projection or 3-dimensional projection) of an area occupied by the robot 102 on the computer-readable map. According to at least one non-limiting exemplary embodiment, the received computer-readable map and route may comprise in part a pose graph, wherein the footprint 712 is projected at each point of the pose graph to detect collisions as illustrated in FIG. 7A-B above. According to at least one non-limiting exemplary embodiment, the route may comprise a continuous path or line, wherein the at least one footprint 712 may be virtually (i.e., simulated) moved along the route on the computer-readable map. According to at least one non-limiting exemplary embodiment, a plurality of footprints 712 is positioned along the route separated by a fixed distance (e.g., every 2 meters along the route).

Block 806 comprises the controller 118 detecting collisions along the route using the footprints 712. Detection of a collision comprises at least one of the footprints 712 superimposed on the computer-readable map overlapping at least in part with one or more objects.

Upon the controller 118 determining at least one footprint 712 overlaps at least in part with an object on the computer-readable map, the controller 118 moves to block 808.

Upon the controller 118 determining the entire route causes no overlap between a footprint 712 and objects, the controller 118 may move to block 814.

Block 808 comprises the controller 118 modifying the route. According to at least one non-limiting exemplary embodiment, modifications of the route may comprise an iterative process of moving a point of a pose graph, checking for a collision using a footprint 712, and repeating until no collision occurs. According to at least one non-limiting exemplary embodiment, modifications of the route may comprise rubber banding or stretching of the route to cause the robot 102 to execute larger turns or navigate further away from obstacles. According to at least one non-limiting exemplary embodiment, modifications to the route may comprise a use of a cost map, wherein the lowest cost solution (if possible, without collisions) is chosen. A cost map may at least associate a high cost with object collision, a high cost for excessively long routes, and a low cost for a collision-free short route. Other cost parameters may be considered such as tightness of turns or costs for abrupt movements.

Block 810 comprises the controller 118 determining if a collision-free route is possible. If the controller 118 is unable to determine a modification to the route which is, for example, collision free or below a specified cost threshold, the controller 118 may determine no modifications to the route may enable the robot 102 to navigate the route.

Upon the controller 118 determining no modifications to the route enable the robot 102 to execute the route, the controller 118 moves to block 812.

Upon the controller 118 determining a modification to the route which enables the robot 102 to execute the route without collisions, the controller 118 returns to block 806.

Block 812 comprises the controller 118 determining the route is unnavigable without collision with objects. According to at least one non-limiting exemplary embodiment, the controller 118 may communicate this determination to a robot network 210 and/or server 202. Thereafter, the server 202 or network 210 will avoid providing the same route to the robot 102.

Block 814 comprises the controller 118 saving the route data in memory 120 along with any modifications made thereto; and thereafter wait for user input for additional tasks for the robot to complete as reflected in block 310 in FIGS. 3-5 and discussed above.

Advantageously, the method 800 may enable a robot 102 to verify that a received route is navigable without the robot 102 navigating the route itself and, if not, any modifications required to configure the route to become navigable. That is, a succeeding robot 102 may independently verify that a route received from a preceding, different robot 102 is navigable using the received computer-readable map and footprints 712 superimposed thereon.

One skilled in the art would appreciate that in some instances, the most recent preceding route information may be informative, but may not include all information useful for a succeeding route. For illustration, the most recent preceding run of a route may have been at 11:30 PM on Friday and the succeeding route may be executed at 6:00 AM on Saturday. One or more processors may, according to methods described herein, determine that information related to another preceding route executed on a previous Saturday at 6:00 AM may be more indicative of conditions likely to be encountered than information collected in the most recent preceding run at 11:30 PM on Friday. In another example, for a robot of a specific type, size, or capability, selection by one or more processors of a preceding route executed by a robot of the same type, size or capability may be preferable to the most recent preceding run of a route by a robot of a different type, size or capability. One or more processors may, according to methods described herein, compare the most recent preceding route and map data with route and map data of a different preceding route and determine that the most recent route and map data does not impact the ability of a succeeding robot to execute the route for a succeeding run of the different preceding route. Alternatively, the one or more processors may determine that the most recent preceding route and map data does impact the ability of a succeeding robot to execute the route for a succeeding run of the different preceding route. In those instances, one or more processors may, according to methods described herein, modify a preceding route to reflect the route and map data synchronized from the most recent preceding route. For example, a portion of a preceding route may be unchanged and a different portion of that preceding route may be changed to address the new conditions found in the most recent route synchronization. The modified route would then be used for a succeeding run of the route.

FIGS. 9A-B illustrates two robots 102, a first robot 102-1 may be uploading data to the server 202 while the other robot 102-2 is checking if data is available to synchronize with the server 202, according to an exemplary embodiment. Data received from the robot 102-1 may include metadata and binary data. Metadata may include timestamps, an environment ID (i.e., an identification number or code which corresponds to an environment of robot 102-1), a network 210 ID (i.e., an identifier which specifies a robot network 210 which includes robot 102-1), and/or other metadata (e.g., robot ID, route type (e.g., new route or replayed route), etc.). Binary data may include data from sensor units 114, computer-readable maps produced during navigation of a route, performance metrics (e.g., average deviation from the route to avoid obstacles), route data (i.e., the path traveled), and the like. The server 202 may receive communications 902, 904 representing the robot 102-1 communicating the binary data and metadata, respectively, to the server 202, the binary data and metadata correspond to a run of a route (e.g., execution of methods 400 or 500 above). The two communications 902, 904 may be received by the server 202 contemporaneously or sequentially, wherein communicating binary data at a later time may reduce network bandwidth occupied by the robot 102-1 (e.g., robot 102-1 may wait for a Wi-Fi signal to issue communications 902 but may issue communications 904 using LTE or cellular networks).

Server 202 may store binary data 906 and metadata 908 in a memory, such as memory 130 described in FIG. 1B. The server 202 may store the binary data 906 and metadata 908 in a same or separate memory 130. The metadata stored on the server 202 may include, in part, a list of routes corresponding to the environment of robots 102-1 and 102-2, wherein the list of routes may correspond to one or more computer-readable maps of the binary data 906.

Robot 102-2 may have completed a route, learned a new route, or may have been initialized for a first time following the methods illustrated in FIG. 3-5 above. Accordingly, the robot 102-2 may synchronize data with the server 202. For robot 102-2 to check if data is available to be synchronized with the server 202, the robot 102 may communicate with the server 202 to receive metadata 910 associated with the environment. The metadata may include, for example, a list of routes associated with the environment and timestamps corresponding to the routes. The controller 118 of the robot 102-2 may compare the metadata received via communications 910 to determine if the routes stored within memory 120 of the robot 102-2 matche the routes stored in memory of the server 202. In some embodiments, the server 202 may receive metadata from the robot 102-2, such as a ledger 918 shown in FIG. 9B, wherein processing devices 138 of the server 202 may perform the comparison. That is, server 202 may store a list of routes (i.e., metadata 908) corresponding to the environment of robots 102-1 and 102-2, wherein the controller 118 of the robot 102-2 may compare its list (stored locally on memory 120) with the list stored on the server 202. If the controller 118 detects a discrepancy between the two lists, the controller 118 may synchronize the binary data 906 with the server shown by communications 912. Accordingly, the controller 118 may receive up-to-the-moment route and map information corresponding to its environment upon verifying that route and map information stored locally within its memory 120 comprises discrepancies with the route and map information stored on the server 202 by comparing metadata. This comparison is further illustrated next in FIG. 9B.

FIG. 9B illustrates local metadata ledgers 914 and 918 stored in respective memories 120 of the robots 102-1 and 102-2 shown in FIG. 9A above and a metadata ledger 916 of the server 202, according to an exemplary embodiment. As robots 102-1, 102-2 learn, navigate (i.e., replays), or delete routes stored in their respective memories 120, the controllers 118 may keep a ledger 914, 918 to document the behavior of the robot 102 with respect to routes learned, navigated, or deleted. For example, for a route identified by a route ID “AAAA,” the metadata associated with the route ID “AAAA” may include the creation or training of the route (i.e., entry “NEW ROUTE”, wherein the route may be learned in accordance with method 500 above), the replay or navigation of the existing route (i.e., entry “REPLAY” which includes a timestamp denoted by a date), and/or deletion of the route (i.e., entry “DELETE”).

By way of illustration, an operator of robot 102-1 may train a route associated with route ID “AAAA” at a first instance in time. Subsequently, following method 400, the controller 118 may synchronize data with the server 202 which includes providing metadata associated with the new route such as the route ID, a timestamp, an environment or network 210 ID, and/or other metadata not shown (e.g., route length). Accordingly, the server 202 may store the route ID “AAAA” and corresponding metadata which represents that route “AAAA” is a new route in its respective ledger 916. Binary data, such as computer-readable maps, sensor data, route data, and the like associated with the new route “AAAA” may be communicated and stored in a separate memory or in a different location in memory. The server 202 may further provide the same route ID and metadata associated thereto to the second robot 102, wherein the second robot 102 may store the route ID and metadata in its ledger 918. Binary data associated with the route “AAAA” may be communicated to the robot 102-2 and stored in its memory 120 to enable the robot 102-2 to replay the route, as shown in FIG. 6A-B.

At a second instance in time subsequent to the first instance in time, either the robot 102-1 or 102-2 may navigate the same route of route ID “AAAA,” wherein the respective controller 118 stores the metadata associated with the run of the route in its respective ledger 914 or 918. Accordingly, the server 202 and both robots 102-1, 102-2 may, upon synchronization, store the metadata associated with the run of the route in their respective ledgers 914, 916, 918 as shown by the second entries comprising a “REPLAY” and a date and/or time of the replay. Replay corresponds to a robot replaying or renavigation the route for a second, third, fourth, etc. time.

At a third instance in time subsequent to the second instance in time, the robot 102-1 may receive an indication from an operator via its user interface units 112 to delete the route associated with the route ID “AAAA.” Accordingly, the deletion of the route may be denoted in the ledger 914 as shown by the metadata “DELETE” corresponding to the route ID “AAAA.” The robot 102-1 may delete binary data associated with the route from its memory 120. In accordance with methods 300, 400, 500 above, the controller 118 of the robot 102-1 may communicate with the server 202 (via communications 920) to synchronize its ledger 914 with the ledger 916 stored on the server 202 such that the ledger of the server 916 includes deletion of the route associated with the route ID “AAAA.” At a fourth instance in time, subsequent to the third instance, the controller 118 of the second robot 102-2 may compare its ledger 918 with the ledger 916 of the server 202. Alternatively, a processing device 138 of the server 202 may compare its ledger 916 with a ledger 918 received from the robot 102-2. The controller 118 of the robot 102-2 may identify that its ledger 918 differs from the ledger 916 of the server 202 (i.e., checks if data is available to be synchronized) and, upon identifying the discrepancy, the controller 118 synchronizes its ledger 918 with the ledger 916 of the server 202, as shown by arrows 924. Accordingly, the route associated with the route ID “AAAA” may be deleted from memory 120 of the robot 102-2 upon the controller 118 receiving the metadata corresponding to the deletion of the route.

FIG. 10 illustrates binding trees 1000, 1014 used to synchronize routes between robots 102, according to an exemplary embodiment. A binding, as used herein, represents a relationship between two devices, components, or things. A component may comprise a file or other granular piece of data or metadata (e.g., a map for a route). The binding tree represents the relationship between a device, such as a given robot 102, and components such as routes executable by the robot 102. Bindings are represented by the arrows shown in binding tree 1000 and components are akin to the functional blocks thereof, although one skilled in the art may appreciate that the functional blocks shown herein may include numerous components. The binding tree may be stored on both the robot 102 and server 202 to ensure both entities agree upon the current state of the components thereof, wherein any discrepancies may be corrected via synchronization. Each block shown in the binding tree may represent data synchronized between a server 202 and robots 102. That is, both the server 202 and robot 102 continuously synchronize their respective binding trees.

The binding trees illustrated may correspond to two separate environments or sites A and B. Within site A, two robots 102 A and 102 B operate while only one robot operates in site B. Beginning at the device level of robot A, the robot A may be identified by the server 202 using a unique identifier, such as an alphanumeric code. Continuing along the binding tree 1000 the robot A may be bound to a product block 1002 comprising “Product A.” Product A may comprise an identifier for a product, or type of robot. For example, product A may correspond to a floor-sweeping robot, an item-transport robot, a floor-scrubbing robot, and so forth. Stated differently, the product block 1002 may identify a shelf-keeping unit (“SKU”), universal product code (“UPC”), or other unique identifier for a specific robot type. The specific value represented by the product blocks 1002 may be pre-determined by a manufacturer of the robot 102.

The robot 102, now bound to a specific product type, is bound to an activation block 1004. The activation block 1004 may include customer information used to indicate that the robot 102 is activated by the manufacturer of the robot 102. Robots 102 produced by a manufacturer may be left inactivated until they are purchased by a consumer, wherein the activation block 1004 binds the robot A to the consumer. In some embodiments, the consumer may pay a recurring service fee for maintenance and autonomy services of the robot 102, wherein the activation data may be used to create billing information for the consumer.

If the consumer, later, no longer desires to utilize the robot 102 and pay the service fees, the data in activation A block 1004 may be changed from “Active” to “Deactivate.” The change may be performed on the robot 102 via user interface units 112 or on the server 202 via a device 208, such as an admin terminal. In either case, and based on method 300, the update to the binding tree 1000 will be synchronized between the robot A, server 202, and robot B such that both the server 202 and robot B include a binding tree 1000 with no robot A or at least a deactivated robot A.

Continuing along the binding tree 1000, the robot A (now associated with a product type and consumer activation) may now be bound to a site 1006. The site 1006 block may represent a unique identifier, or other metadata, for the environment the consumer would desire the robot 102 to operate in. In addition to robot A, robot B (also bound to its own product type and consumer activation, which may be the same or different from robot A) is also bound to the site A indicating that both robots 102 operate within this environment.

Site and activation blocks 1004, 1006 are denoted as separate blocks of information to facilitate transfer of a robot 102 from site A to another site owned by the same consumer. That is, the activation 1004 of the robot 102 may be the same in the new environment while the site 1006 is updated.

In some instances, ownership of the robot 102 may change while the robot 102 continues to operate at site A.

Further down the binding tree 1000, the robot 102, being now bound to a product type, activation information, and site information, is further bound to various home codes 1008 A, B, and C. The home codes 1008 may represent three landmarks recognizable by the robot 102 as a start of a route, such as landmarks 602 or 700 shown in FIG. 6-7 above. A home code 1008 may be bound to the site A 1006 upon robot A or B 102, bound to the site 1006, detecting a home code 1008 before, during, or after learning a route 1010. Each home code 1008 may denote the start, end, or midpoint of one or many routes associated with the home code 1008. Looking further at home code A 1008, home code A 1008 is bound to two routes 1010-Al and 1010-A2. The routes 1010 may be bound to the home code A 1008 by an operator training either robot A or robot B to learn the routes 1010-Al and 1010-A2, wherein the training of the routes 1010-Al and 1010-A2 begins, ends, or includes the robot 102 detecting the home code A 1008. Similarly, home codes B and C are also bound to site A and their respective routes, wherein the number of routes bound to the home codes 1008 is not intended to be limited to two as shown and may be more or fewer.

Each route 1010 may comprise route components 1012 needed by the robot 102 to recreate the route autonomously; only one set of route components 1012 for route 1010-A2 is shown for clarity. The route components 1012 may include binary data and may include pose graphs, route information, computer-readable maps, and/or any other data needed by the robot 102 to recreate the route autonomously. Assuming robot A learned route 1010-A2 and generated the route components 1012, the route components 1012 may be synchronized with robot B following method 300, wherein the server 202 synchronizes its binding tree 1000 stored in its memory to include route components 1012 from robot A which is subsequently transferred to robot B. Shared data 1016 illustrates the data shared between robots 102 A and B, wherein the shared data includes the site data 1006 and route data (i.e., home code data 1008 and route components 1012). The binding tree 1000 may indicate to the server 202 which robots 102 connected to the server 202 should receive the route components 1012. Specifically, the server 202 only synchronizes binary route components 1012 with robot B since robot B is within the same site A 1006. Robot C, shown in binding tree 1014, does not receive the route A2 components 1012, or any components 1012 of any routes 1010 associated with Site A.

Assuming no further updates are made to the binary route components 1012, such as changes to the shape of the route (e.g., as provided to a user interface 112 of a robot 102), the binary data remains static without a need for synchronization. If a route component is changed, a discrepancy between the binding tree 1000 of the robot 102 and the binding tree 1000 stored in the server 202 arises. When a route component 1012 is created, edited, or deleted, the robot 102 may note the change as a change to site A. For example, a parameter stored in memory 120 on the robot 102 may change value from 0 (no change) to 1 (change) upon one or more home codes 1008, routes 1010, and/or route components being created, deleted, or edited. Upon the parameter changing to a value indicating a change to the binding tree at the site A 1006 level or below, the robot 102 may ping the server 202 with an indication that the site data 1006 has changed locally on the device, thereby requiring synchronization.

The server 202, in response to the ping, may issue communications to other robots 102 bound to the same site 1006. Such communication may enable the other robots 102 to know that data is available to sync before the binary data is synchronized. By way of an illustrative example, robot A may issue a ping to the server 202 to indicate a change to any component of the shared data 1016. In response to this ping, the server 202 issues a communication to robot B indicating the change occurred and that new data is available to be synchronized. In some instances, robot B may display on its user interface 112 that data is available to be synchronized. An operator of robot B may, upon noticing that data is available to be synchronized, pause autonomous operation of robot B until after the data is synchronized. In other embodiments, the data is synchronized automatically upon robot B receiving indication of a change to the shared data 1016, provided robot B includes a secure connection to the server 202 and is not pre-occupied with other tasks.

Upon detecting the update to the shared data 1016 from the robot 102 via the received ping, the server 202 will update its binding tree 1000 using binary data shared from the robot 102. This binary data is subsequently synchronized to the remaining robots 102 at site A such that the remaining robots 102 include the modified shared data 1016. The server 202 further updates the metadata, such as timestamps, of route components 1012 stored in its memory (e.g., ledger 916) and on the robot 102 memory 120 (e.g., ledger 914, 918) such that each robot 102 includes an up-to-date ledger 914, 918 and up-to-date binding tree 1000 locally.

A binding tree may be generated for each robot 102 coupled to the server 202 to enable the server 202 to determine relationships between a given robot 102 and its various operating parameters, such as the types of robots, the site information 1006, activation information 1004, route information, and the like. With reference to FIG. 2, the binding tree 1000 may define parameters and relationship between the server 202 and any given robot 102 of a robot network 210. Binding trees enable the server 202 to determine which robots 102 synchronize databy ensuring binary data is only synchronized between robots 102 bound to a same site and, in some embodiments, robots 102 of a same product type 1002.

Advantageously, by tracking changes to the binding tree, the server 202 and robots 102 coupled to a site may be aware of any changes to be synchronized before the binary data is synchronized which may indicate to users of the robots 102 that data can be synchronized for more efficient usage of their robots 102. Further, by detecting a change to the binding tree 1000 locally on the robot 102 via determining if a change to shared data 1016 occurred, the query time taken by the server 202 to detect if a change to shared data 1016 occurred is reduced.

It will be recognized that while certain aspects of the disclosure are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open-ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation”; the term “includes” should be interpreted as “includes but is not limited to”; the term “example” or the abbreviation “e.g.” is used to provide exemplary instances of the item in discussion, not an exhaustive or limiting list thereof, and should be interpreted as “example, but without limitation”; the term “illustration” is used to provide illustrative instances of the item in discussion, not an exhaustive or limiting list thereof, and should be interpreted as “illustration, but without limitation”; adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for causing a succeeding robot to navigate a route, comprising:
receiving a computer readable map, the computer readable map being produced based on data collected by at least one sensor of a preceding robot during navigation of the route by the preceding robot at a preceding instance in time; and
navigating, by the succeeding robot, the route at a succeeding instance in time based on the computer readable map, the succeeding instance in time being after the preceding instance in time.

2. The method of claim 1, further comprising:
communicating by the preceding robot the computer readable map to a server upon completion of the route by the succeeding route, the server communicatively coupled to both the succeeding robot and the preceding robot.

3. The method of claim 1, further comprising:
synchronizing data with a server upon initializing the succeeding robot from an idle or off state, the synchronized data comprising at least the computer readable map of the route, the server being communicatively coupled to both the succeeding robot and the preceding robot.

4. The method of claim 1, wherein,
the preceding robot navigates the route for an initial time in a training mode during the preceding instance in time; and
the succeeding robot navigates the route for the succeeding time by recreating the route executed by the preceding robot during the preceding instance in time.

5. The method of claim 1, wherein,
the route begins and ends proximate to a landmark or feature identified by sensors of the succeeding and preceding robots.

6. The method of claim 1, wherein,
the computer readable map comprises a pose graph indicative of positions of the preceding robot during navigation of the route.

7. A system, comprising:
a non-transitory computer readable storage medium comprising computer readable instructions embodied thereon; and
at least one processor configured to execute the computer readable instructions to,
receive a computer readable map, the computer readable map being generated based on data collected by at least one sensor of a preceding robot during navigation of a route by the preceding robot at a preceding instance in time; and
configure a succeeding robot to navigate the route at a succeeding instance in time based on the computer readable map, the succeeding instance in time being after the preceding instance in time.

8. The system of claim 7, wherein,
the preceding robot, upon completing the route, communicates the computer readable map to a server communicatively coupled to both the succeeding robot and the preceding robot.

9. The system of claim 7, wherein the at least one processor is further configured to execute the computer readable instructions to,
synchronize data with the succeeding robot upon the succeeding robot being initialized from an idle or off state, the synchronized data comprises at least the computer readable map of the route produced by the preceding robot.

10. The system of claim 7, wherein,
the preceding robot navigates the route for an initial time in a training mode during the preceding instance in time; and
the succeeding robot navigates the route for the succeeding time by recreating
the route executed by the preceding robot during the preceding instance in time.

11. The system of claim 7, wherein the route begins and ends proximate to a landmark or feature identified by sensors of the succeeding and preceding robots.

12. The system of claim 7, wherein the computer readable map comprises a pose graph indicative of positions of the preceding robot during navigation of the route.

13. A non-transitory computer readable medium comprising computer readable instructions stored thereon that when executed by at least one processor configure the at least one processor to,
receive a computer readable map, the computer readable map being produced based on data collected by at least one sensor of a preceding robot during navigation of the route by the preceding robot at a preceding instance in time; and
navigate, by the succeeding robot, the route at a succeeding instance in time based on the computer readable map, the succeeding instance in time being after the preceding instance in time,
wherein,
the preceding robot navigates the route for an initial time in a training mode during the preceding instance in time, and
the succeeding robot navigates the route for the succeeding time by recreating the route executed by the preceding robot during the preceding instance in time.

14. The non-transitory computer readable medium of claim 13, wherein the at least one processor is further configured to execute the computer readable instructions to,
communicate by the preceding robot the computer readable map to a server upon completion of the route by the succeeding route, the server communicatively coupled to both the succeeding robot and the preceding robot.

15. The non-transitory computer readable medium of claim 13, wherein the at least one processor is further configured to execute the computer readable instructions to,
synchronize data with a server upon initializing the succeeding robot from an idle or off state, the synchronized data comprising at least the computer readable map of the route, the server being communicatively coupled to both the succeeding robot and the preceding robot.
